(19) United States
(12) Patent Application Publication
(10) Pub. No.: US 2005/0250401 A1
(43) Pub. Date: Nov. 10, 2005

(54) Compost coating material

(76) Inventor: Shigeru Baba, Chiba-ken (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/124,442

(22) Filed: May 6, 2005

Related U.S. Application Data
(60) Provisional application No. 60/569,128, filed on May 7, 2004.

(51) Int. Cl. B32B 27/12

(52) U.S. Cl. 442/59; 442/394; 442/400; 442/401

(57) ABSTRACT

A compost coating material comprising a porous, spun-bond, nonwoven fabric and a moisture-permeable, water-resistant, non-porous film, wherein the coating material has a moisture permeability of about 300 g/m²·24 h or greater under conditions of 40° C. and 90% relative humidity, and a water pressure resistance of about 1000 mm or greater.

### BACKGROUND OF THE INVENTION

1. Field of the Invention

The present invention relates to coating material for covering compost piles and in particular for composting livestock excrement deposited outdoors.

2. Description of the Related Art

In recent years, some of the excrement from livestock in the livestock industry has been composted for reuse, however, most of it is deposited and left outdoors. This leads to environmental problems such as groundwater contamination, dispersion of odor into the surroundings, and river contamination caused by rainwater run-off. However, in some parts of the world, leaving livestock excrement out in the open is prohibited by law, and thus, there is now a demand for composting and treating such material.

It is important that composting of excrement from livestock be inexpensive and easy. Various proposals have been made to achieve these ends. For example, an excrement deposit coating material is described in Japanese Examined Patent Application No. 3286548 that is porous, or is composed of a laminate of a porous polyolefin film and a porous cloth, and has a moisture permeability of 1500 g/m²·24 h or greater, a water pressure resistance of 0.1 kgf/cm² or greater, and an air permeability of 3000 sec/100 cc or less. An aerobic treatment bag has also been described in Unexamined Utility Model Application No. Sho 57[1983]-129749, which is constituted by a polyethylene spun-bond nonwoven cloth. The aforementioned sheets composed of porous films and porous nonwoven cloths have some degree of water resistance, moisture permeability and air permeability, but problems remain with reducing composting time and with rain leakage due to the natural decrease in water resistance exhibited by the sheets over time. Solutions to these problems are strongly desired in order to cover livestock excrement that has accumulated outdoors while also allowing it to compost.

### BRIEF DESCRIPTION OF THE DRAWING

The figure is a graph showing the relationship between permeability resistance and humidity.

### DETAILED DESCRIPTION OF THE INVENTION

One object of the present invention is to provide a material for coating the surface of livestock excrement that has been deposited on the ground in a compost pile, thereby facilitating the drying and fermentation of the excrement deposit, wherein the coating material can shorten the composting time and resolve problems with rain leakage due to loss of water pressure resistance over time, while also having excellent strength and workability. It is noted that the subject coating material is not necessarily limited to composting of livestock excrement and that it can be used in other applications where its properties may be suitable.

The inventors of the present invention, in order to resolve these problems, have discovered that a composite sheet of a porous polyolefin nonwoven fabric layer and a non-porous film is very good for such an application. Specifically, the coating material of the present invention is constituted by a composite sheet comprising a porous spun-bond nonwoven fabric employing polypropylene filament and a non-porous polyvinyl alcohol film that is moisture permeable and water resistant, wherein the moisture permeability of the composite sheet, as measured according to the revised method of JIS-Z0280, is 300 g/m²·24 h or greater under conditions of 40° C./90% relative humidity (RH) and the water pressure resistance of the composite sheet, as measured by the method of JIS-L-1096A (low water pressure method) is 2000 mm or greater.

According to another aspect of the present invention, the weight of the nonwoven fabric in the coating material is 60 g/m² to 240 g/m².

In the composite sheet of the invention, the porous spun-bond nonwoven fabric is produced using polypropylene filament. The fabric can be manufactured by any conventional known methods generally used to form thermoplastic spun-bond webs, wherein a thermoplastic resin such as polypropylene, polyamide or polyester is formed into the constituent fibers and after melting the resin, the material is extruded, taken off with an air sucker, and distributed on a net conveyor, where it is bonded. One non-limiting example of this type of polypropylene spun-bond nonwoven fabric is Xavan® manufactured by E. I. du Pont de Nemours and Company, Wilmington, Del. (DuPont).

The spun-bond nonwoven fabric preferably comprises polypropylene in consideration of its chemical stability and its suitability for recycling and reducing problems with waste treatment. A lightweight composite sheet cannot be produced if the weight of the nonwoven fabric is too high. The basis weight of the film is about 14 g/m² and the amount of adhesive is typically about 3 to 6 g/m². The basis weight of the composite sheet is preferably about 80-260 g/m², with 65-220 g/m² being particularly preferred. The weight of the nonwoven fabric causes variation in the strength and workability of the composite sheet when it is used as an actual coating material; and if the coating material is too light in weight, then the tensile strength will be insufficient and the material will readily rupture. If the coating material is too thick, on the other hand, workability will suffer which is undesirable.

Polypropylene can degrade resulting in exposure to ultraviolet light, so it is desirable to blend an ultraviolet absorber in the raw material resin used in manufacturing the nonwoven fabric. In general, ultraviolet absorbers based on benzotriazole, benzophenone or benzoate can be used. Examples are Irganox® 1010 and Tinuvin® 622 or 770 (all available from Ciba Specialty Chemicals Corporation), and it is possible to achieve stabilization by using combinations thereof.

There are no particular restrictions on the non-porous film composed of polyvinyl alcohol resin used as an element in the basic constitution of the composite sheet of the present invention. A biaxially drawn, non-porous, moisture-permeable, water-resistant polyvinyl alcohol resin film manufactured by Nippon Gosei Chemical Industries may be used. It is desired that the coating material of the present invention have durability, hydrolyzability, and ultraviolet radiation resistance, while also maintaining, in particular, the desired moisture permeability during use. It is thus preferable for the non-porous film to be formed from polyvinyl alcohol resin. The non-porous film referred to in the present invention is made from a polyvinyl alcohol resin synthesized such that the resultant film has both water resistance and moisture permeability. The thickness of the film produced from the resin synthesized in the manner described above is preferably 10 to 50 micrometers. If the thickness is less than 10 micrometers, there is the disadvantage that the material will readily tear during film production or during handling. If the film exceeds about 50 micrometers, it will be too thick and the moisture permeability and flexibility may suffer. It is preferable to use a film that has moisture permeability of at least 100 g/m²·24 h, and more preferably at least 200 g/m²·24 h, and a water resistance of at least 1000 mm H₂O, and more preferably at least 2000 mm H₂O.

The method for producing the composite sheet of the invention using the spun-bond nonwoven fabric and the polyvinyl alcohol film may be a method involving partial thermal lamination, application of a liquid adhesive, formation of hot-melt powder coating, or dispersion-application of a hot-melt adhesive in the form of a fiber. Formation of the composite sheet of the present invention refers to the lamination and integration of the spun-bond nonwoven fabric and the polyvinyl alcohol film. Regardless of the method used, it is important that it not interfere with the water resistance and moisture permeability of the resulting composite sheet. In a preferred embodiment, a urethane-based resin used as a liquid hot melt adhesive is applied to the aforementioned nonwoven fabric by means of a coater that can provide dot application and whereupon the fabric and film are joined through hot-pressing. The amount of hot melt adhesive can be in the range of 3 to 30 g/m², and preferably about 3 to 6 g/m². It is important that the hot melt adhesive joins the two types of members without causing delamination (i.e., the layers peeling away from each other). If the adhesive strength is weak, then delamination of the two layers will occur when, for example, the composite sheet is subjected to high water pressure and only the stretchable resin fabric will expand, leading to rupture. In order to provide both moisture permeability and water resistance, it is particularly desirable to use a method wherein, after dot-lamination using a hot-melt agent, adhesion is brought about by curing and aging for about 24 hours at 40° C.

A preferred embodiment of the composite sheet is a laminate obtained by dot-adhesion of a non-porous film composed of polyvinyl alcohol resin to Xavan® BF polypropylene spun-bond nonwoven fabric, manufactured by DuPont.

The moisture resistance of the composite sheet composed of porous spun-bond nonwoven cloth and non-porous film of the present invention provides a moisture permeability of 300-400 g/m²·24 h, as measured according to JIS Z-0208 (modified method) under normal measurement conditions of 40° C. and 90% RH.

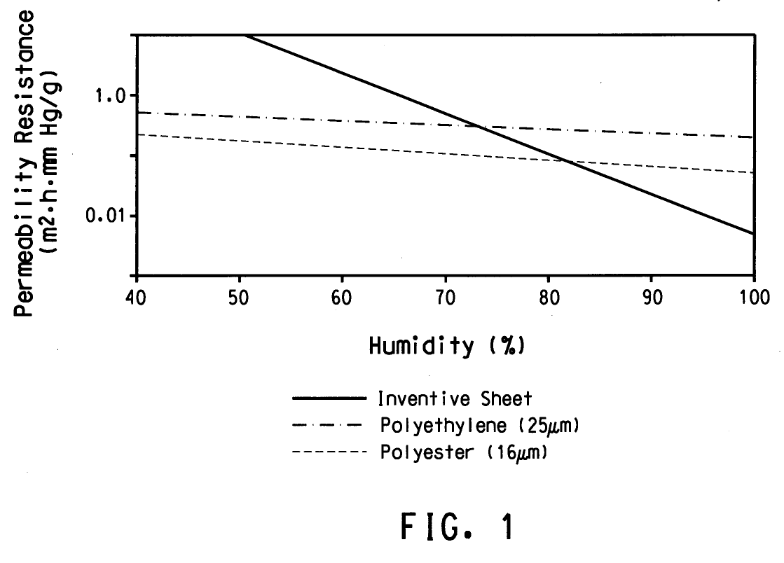

FIG. 1 shows the relationship between moisture permeation resistance (or moisture vapor transmission rate (MVTR), measured as m²·h·mmHg/g) at 20° C. and % relative humidity for the composite sheet of the invention using Xavan® BF as the porous, spun-bond, nonwoven fabric. The relationship for polyethylene and polyester are also shown for purposes of comparison. The polyethylene is generally representative of the base material of Comparative Examples 1-2. From FIG. 1, it can be seen that moisture permeability resistance decreases with increasing average relative humidity for all three materials, but more so with the inventive material. It is thus possible to accelerate drying and fermentation without allowing an increase in water content in the compost, because the moisture permeability increases along with the naturally expected increase in temperature occurring with water vapor evaporation due to the heat generated in composting resulting from progression of fermentation which is a process in composting. As a result, the composting time can be shortened. Specifically, in the relationship between humidity and moisture permeability resistance, as shown in FIG. 1, the moisture permeability resistance decreases dramatically with increasing humidity for the inventive material. In short, when the relative humidity is 70% or greater, the moisture permeability resistance is 1 m²·h·mm Hg/g or less, and as the temperature and moisture levels increase during the composting process, there is no impediment to the evaporation of water vapor from the excrement, thus contributing to the acceleration of composting. On the other hand, with conventional coating materials or coating materials composed of laminates of porous polyolefin film and porous sheet, as described in Japanese Examined Patent Application No. 3286548, the moisture permeability measured at 40° C. according to JIS Z-0208 is 1500 g/m²124 h, but the moisture permeability does not vary significantly with respect to changes in humidity and temperature accompanying the composting process. Without being held to any particular theory, this is thought to be the reason that it is difficult to decrease composting time and to solve problems with rain leakage due to loss of water resistance over time with conventional materials as described above.

### EXAMPLES

Examples of the present invention are described in detail below, but are not in any way intended to restrict the content of the present invention.

The methods for measuring physical properties of the composite sheet are also provided.
1. Tensile strength and elongation carried out according to JIS L-1096.
2. Tensile strength carried out according to method A-1 of JIS L-1096.
3. Tensile break strength carried out according to method A-1 of JIS L-1096.
4. Rupture strength carried out according to method JIS-P-8112.
5. Water resistance carried out according to method A of JIS-L-1096 (low water pressure method).
6. Moisture permeability carried out according to the revised method of JIS-Z0280.
   Normal measurement conditions: 40° C., 90% RH.

All of the characteristics (tensile strength, elongation, elongation break strength, rupture strength, water pressure resistance, moisture permeability, weight, and thickness) of the sheets obtained in the working examples are presented in Table 1. Whereas for the comparative examples, only water pressure resistance and moisture permeability, which have an influence on use as the coating material of the present invention are presented.

### Example 1

Xavan® 7137W, a polypropylene spun-bond nonwoven fabric (having a basis weight of 45 g/m², not containing ultraviolet absorber), and Bovion® film, a 14 μm-thick polyvinyl alcohol resin film (manufactured by Nippon Synthetic Chemical Industry Co., Ltd.), were adhered using dot-adhesion. A polyurethane-based hot melt adhesive (moisture-curing urethane resin) was applied at an application rate of 5-8 g/m² on one surface of the nonwoven fabric, after which the film was applied to the adhesive and the material was passed through heated rolls and hot-pressed in order to produce a composite sheet. The physical properties of the composite sheet are shown in Table 1.

### Example 2

Xavan® 5201 B (manufactured by DuPont), a polypropylene spun-bond nonwoven cloth (having a basis weight of 68 g/m², containing ultraviolet absorber) was dot adhered to the Bovlon® film as described in Example 1. The physical properties of the composite sheet are shown in Table 1.

### Comparative Examples 1-2

Comparative Example 1 was a sheet produced by sandwiching a polyethylene microporous film between two sheets of Warifu (a split fiber nonwoven net-like fabric manufactured by Nisseki).

Comparative Example 2 was a sheet produced by reinforcing both sides of a microporous polyethylene film with a polyethylene flat yarn woven cloth. Results are shown in Table 1.

TABLE 1
Physical properties of compost covering sheet

| | | | | Comparative | Comparative |
|---|---|---|---|---|---|
| | | Example 1 | Example 2 | Example 1 | Example 2 |
| Tensile strength | Longitudinal | 22.0 | 28.8 | 40.7 | |
| (kgf/5 cm) | Transverse | 18.2 | 26.4 | 31.4 | |
| Elongation (%) | Longitudinal | 34.6 | 46.1 | | |
| | Transverse | 62.7 | 31.4 | | |
| Tensile break | Longitudinal | 2.7 | 3.9 | 3.2 | |
| strength (kgf) | Transverse | 3.9 | 4.2 | | |
| Rupture strength | | 6.9 | 7.3 | | |
| (kgf/cm²) | | | | | |
| Water pressure | | >2000 | >2000 | >1400 | 900 |
| resistance | | | | | |
| (mm H₂O) | | | | | |
| Moisture | | 360 | 341 | 4937 | 6150 |
| permeability | | | | | |
| (g/m²/day) | | | | | |
| Weight (g/m²) | | 72 | 82 | | |
| Thickness (mm) | | 0.21 | 0.23 | | 0.5 |

Composting tests were carried out over a 2-month period from Jul. 29 to Sep. 30, 2003 at Kato Pastures, Hanazo-machi, Saitama prefecture, where approximately 200 head of dairy cattle were being reared by a dairy farm. The test quantities are described below. Composting was carried out undisturbed, without turning over the material.

Compost piles having the dimensions indicated below were covered with the sheets (6 m×8 m) of the comparative examples and working example:

Bottom: 2.8 m; height: 1.5 m; diagonal: 2 m; depth: 5 m. The degree of composting was measured as the depth, in centimeters, of fermented material (compost) on the top of the compost pile. Table 2 shows the results of carrying out the above composting test for Working Example 1 and the Comparative Examples.

TABLE 2
Composting sheet test results

| | Working | Comparative | Comparative | |
|---|---|---|---|---|
| | Example 1 | Example 1 | Example 2 | Uncovered |
| Compost internal | | | | |
| temperature (° C.): | | | | |
| Maximum value | 62.5 | 51.2 | 50.5 | 47.6 |
| Minimum value | 34.2 | 32.7 | 21.2 | 21.1 |
| Average value | 48.8 | 44.4 | 44.2 | 41.5 |
| Degree of | 30 | 20 | 15 | 0 |
| composting (cm) | | | | |

As seen in Table 2, the temperature of the compost using the composite sheet of Working Example 1 was higher on average and, in addition, the maximum temperature was also higher, relative to the comparative examples. Temperatures were measured at two points in a central portion of the compost piles by a thermometer connected to an automatic recorder (available from Chino). There was a significant change in air temperature during the day. The temperature of the compost pile is dependent on the air temperature (i.e., becoming higher in daytime and cooler at night), but goes up gradually over time. This is thought to be due to poor temperature retention resulting from the low weight of 45 g/m² of the porous spun-bond nonwoven cloth used in Working Example 1. The high average temperature is thought to be due to the action of fermentation, which is taking place rapidly under higher inside temperature because of the exothermic effect. It can also be seen from Table 2 that no observable changes occurred to the compost pile when left uncovered. Fermentation and composting progressed up to 30 cm from the top of the compost in Working Example 1 and the respective distances were 20 cm and 15 cm in Comparative Examples 1 and 2. This demonstrates that the working example provided increased fermentation and composting over larger areas of the compost pile. It was thus confirmed that the excrement deposit coating material of the present invention had exceptional properties. Because Working Example 1 did not include an ultraviolet absorber, sporadic rupturing occurred after 2 months.

1. A compost coating material comprising a porous, spun-bond, nonwoven fabric and a moisture-permeable, water-resistant, non-porous film, wherein the coating material has a moisture permeability as measured according to the revised method of JIS-Z0280, of about 300 g/m²·24 h or greater under conditions of 40° C. and 90% relative humidity, and a water pressure resistance, as measured by the method of JIS-L-1096A (low water pressure method), of about 1000 mm or greater.

2. The coating material of claim 1, wherein the nonwoven fabric is selected from the group consisting of polypropylene, polyamide and polyester.

3. The coating material of claim 2, wherein the film is polyvinyl alcohol.

4. The coating material of claim 1, wherein the nonwoven fabric is polypropylene and the film is polyvinyl alcohol.

5. The coating material according to claim 1, wherein the basis weight of the nonwoven fabric is about 60 g/m² to 240 g/m².

6. The coating material of claim 1, wherein the film has a basis weight of about 14 g/m²

7. The coating material of claim 1, comprising an ultraviolet absorber.

8. The coating material of claim 1, wherein the film has a thickness of about 10 to 50 micrometers.

9. The coating material of claim 1, having a basis weight of about 80 to 260 g/m².

10. The coating material of claim 9, having a basis weight of about 65 to 220 g/m².
